(19) United States
(12) Patent Application Publication
(10) Pub. No.: US 2002/0090273 A1
(43) Pub. Date: Jul. 11, 2002

(54) Roughing and finishing rotary tool apparatus and method

(76) Inventor: Ronald K. Serwa, Hatley, WI (US)

Correspondence Address: Gerald L. Fellows, Michael Best & Friedrich LLP, 100 East Wisconsin Avenue, Milwaukee, WI, 53202-4108, US

(21) Appl. No.: 09/757,953

(22) Filed: Jan. 10, 2001

(51) Int. Cl. B23C 5/10; B23B 51/00; B23B 35/00; B23C 5/06

(52) U.S. Cl. 409/132; 408/230; 407/54

(57) ABSTRACT

The rotary cutting tool of the present invention employs roughing and finishing blades on the same tool to produce roughing and finishing cuts in one cutting operation. The rotary cutting tool preferably has a roughing flute adjacent to each roughing blade and a finishing flute adjacent to each finishing blade. In highly preferred embodiments, the finishing flutes are smaller than the roughing flutes. Preferably, each finishing flute is located closer to the preceding roughing flute (with reference to tool rotational direction) than to the following roughing flute. The flutes are therefore preferably unequally spaced. In some highly preferred embodiments, the blades are unequally circumferentially spaced and are immediately behind the flutes. At least one finishing blade preferably extends radially farther than at least one roughing blade. Most preferably, all of the finishing blades extend radially farther than all of the roughing blades.

### FIELD OF THE INVENTION

The present invention relates to rotary tools and methods, and more particularly to fluted rotary tools and methods for drilling and/or milling operations on a workpiece.

### BACKGROUND OF THE INVENTION

Drilling, milling, and other rotary cutting operations upon a workpiece often require performance of a roughing cut followed by a finishing cut. Typically, the roughing cut removes a relatively large amount of material from the workpiece while the finishing cut removes a smaller amount of material to clean up the rough cut surfaces. Roughing and finishing cuts are commonly needed for many types of drilling, milling, and other rotary cutting operations and for many types of worked materials. Accordingly, the following description and the present invention applies to roughing and finishing tools for any type of drilling, milling, and other rotary cutting operations (including without limitation drilling holes, milling grooves, slots, or apertures, and the like), and for cutting operations upon any type of material (including without limitation wood, metal, plastic and other synthetic materials, stone, composites, ceramics, and the like). The following description and present invention therefore applies to any conventional rotary cutting tool, such as drill bits, mill bits, router bits, countersink bits, and the like. The term “rotary cutting tool” as used herein and in the appended claims refers to any such tool.

Unfortunately, the need to perform separate roughing and finishing cutting operations has generated the need for separate roughing and finishing rotary cutting tools. Although well-suited for performing roughing or finishing cuts upon a workpiece, two tools are therefore needed for every cutting operation. This represents a significant expense not only in tool cost but also in the time needed to change cutting tools and/or the added cost of separate tool driving devices for the roughing and finishing tools.

Rotary cutting tools typically employ multiple flutes spaced circumferentially around the body of the tool and running along the tool. Different numbers of flutes exist for different rotary cutting tools, and can run either parallel to the rotational axis of the cutting tool or (more commonly) in a helix about the rotary cutting tool. Typically, each flute has an adjacent cutting blade running alongside the flute for cutting material as the rotary cutting tool is turned. The material (usually in chip form) cut by the blades enters the flutes and is conveyed along the flutes away from the tip of the rotary cutting tool as the tool rotates.

Conventional designs for such rotary cutting tools employ a number of cutting blades, each of which is equally spaced about the circumference of the tool. As used herein and in the appended claims, the term “circumference” is employed to indicate angular position about the axis of a rotary cutting tool, and does not indicate or imply the shape of the tool or any particular cross-section thereof. Equally spaced blades are employed to insure that the blades are evenly loaded and that blade wear is therefore distributed evenly among the blades. Also for these purposes, the flutes are the same size to equally distribute chip load among the flutes, and the blades have the same height (radial distance from the rotational axis of the rotary cutting tool).

A rotary cutting tool which can perform both roughing and finishing cuts well remains an elusive goal. For conventional rotary cutting tools having equally spaced blades and a relatively large circumferential distance between successive blades is employed for enabling rougher cuts, but is inappropriate for finishing cuts where smaller finishing flutes can quickly become overloaded (thereby quickly dulling blades and shortening blade life). Although rough cutting operations can often be performed by dull blades, finishing cuts must be performed with sharp blades for acceptable results. On the other hand, a smaller circumferential distance between successive blades is employed for enabling finishing cuts, but is inappropriate for roughing cuts where larger amounts of material must be cut by the same blades (thereby also quickly dulling blades and shortening blade life). Due at least in part to these design limitations, a compromise between blades and flutes capable of performing roughing cuts and blades and flutes better suited for performing finishing cuts has not been reached in the conventional rotary cutting tool art.

Conventional rotary cutting tool design has also been limited by other design considerations well known to those skilled in the art. For example, rotary cutting tool designs are limited by strength requirements. The internal portion or “web” of the rotary cutting tool must have a sufficiently large cross section to withstand the stresses generated at the highest ratings for the tool. As another example, the rotary cutting tool should be designed to have little to no harmonic vibrations in the range of tool operating speeds. Also, the rotary cutting tool should be capable of operating quickly while still generating high-quality finished surfaces. Still other design considerations such as tool balance and weight limit the possible designs for rotary cutting tools.

In light of the problems and limitations of conventional rotary cutting tools described above, a need exists for a rotary cutting tool that can perform both roughing and finishing cutting operations upon a workpiece, can do so without compromising roughing cut and finishing cut quality, can cut rapidly, has a long tool life, is resistant to flute clogging, and is well balanced, strong, and is less susceptible to harmonic vibrations during operation. Each preferred embodiment of the present invention achieves one or more of these results.

### SUMMARY OF THE INVENTION

The rotary cutting tool of the present invention employs roughing and finishing blades on the same tool to produce roughing and finishing cuts in one cutting operation. One or more roughing blades and one or more finishing blades are employed on the tool, are spaced about the circumference of the tool body, and can be aligned with the tool body axis or can curve around the tool body in helical fashion. Although any pattern of blades around the tool and any relative number of roughing and finishing blades can be used, preferably the roughing blades alternate with the finishing blades and are the same in number as the finishing blades.

Preferably, each blade has an associated adjacent flute. Therefore, the rotary cutting tool preferably has a roughing flute adjacent to each roughing blade and a finishing flute adjacent to each finishing blade. In highly preferred embodiments, the finishing flutes are smaller than the roughing flutes. By employing finishing flutes that are smaller than roughing flutes, the finishing flutes can be located closer to adjacent roughing flutes. Preferably, each finishing flute is located closer to the preceding roughing flute (with reference to the direction of rotation of the rotary cutting tool) than to the following roughing flute. The flutes on the rotary cutting tool are therefore preferably also unequally spaced. Although alternative embodiments of the present invention employ unequally spaced flutes in which the finishing flutes are not smaller than the roughing flutes, such embodiments are not as preferred.

The roughing and finishing flutes preferably have portions including concave curved surfaces. Also, in some highly preferred embodiments, the radius and maximum depth of the roughing flutes are greater than the radius and maximum depth of the finishing flutes (to result in larger roughing flutes as described above).

The roughing and finishing blades are each preferably immediately behind a corresponding roughing and finishing flute, respectively. Therefore, in some highly preferred embodiments of the present invention, the blades are unequally spaced about the circumference of the tool body. Such unequal blade spacing helps to reduce tool harmonic vibrations.

Preferably, at least one finishing blade is higher (extends radially farther) than at least one roughing blade on the rotary cutting tool. Therefore, at least one of the finishing blades cuts material that is left uncut by the roughing blades. Most preferably, all of the finishing blades are higher than all of the roughing blades.

By virtue of the differently-sized roughing and finishing flutes and the unequal flute spacing in preferred embodiments of the present invention as described above, the webs of the rotary cutting tool body can be larger and therefore stronger. Also, such tool features can result in webs having unique desired shapes, such as webs that are longer than they are wide.

In operation, a roughing blade is rotated to preferably cut a relatively large amount of material from a surface of a workpiece, after which time an adjacent and following finishing blade is rotated to cut deeper into the surface by the preferably greater height of the finishing blade. Preferably, the finishing blade finely cuts a smaller amount of material from the surface to “clean up” or finish the surface. The smaller finishing flute ahead of the finishing blade does not become clogged with chip material because it is relatively close behind the preceding roughing blade and flute (enabled by the smaller size of the finishing flute and the unequal blade and flute spacing). Also, because the finishing blade is preferably relatively close to the preceding roughing blade, the finishing blade does not become overloaded or experience undue wear. The tool life of the rotary cutting tool is therefore significantly extended. Continued rotation of the rotary cutting tool preferably brings alternating roughing and finishing blades into contact with the surface of the workpiece to produce a finished surface comparable to surfaces cut by conventional finishing tools but at much faster rates than are possible by such finishing tools.

Further objects and advantages of the present invention, together with the organization and manner of operation thereof, will become apparent from the following detailed description of the invention when taken in conjunction with the accompanying drawings, wherein like elements have like numerals throughout the drawings.

### BRIEF DESCRIPTION OF THE DRAWINGS

The present invention is further described with reference to the accompanying drawings, which show a preferred embodiment of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention.

In the drawings, wherein like reference numerals indicate like parts:

FIG. 1 is a perspective view of a rotary cutting tool according to a preferred embodiment of the present invention;

FIG. 2 is a side view of the rotary cutting tool shown in FIG. 1; and

FIG. 3 is a cross-sectional view of the rotary cutting tool shown in FIGS. 1 and 2, taken along lines 3-3 of FIG. 2.

### DETAILED DESCRIPTION OF THE PREFERRED EMBODIMENTS

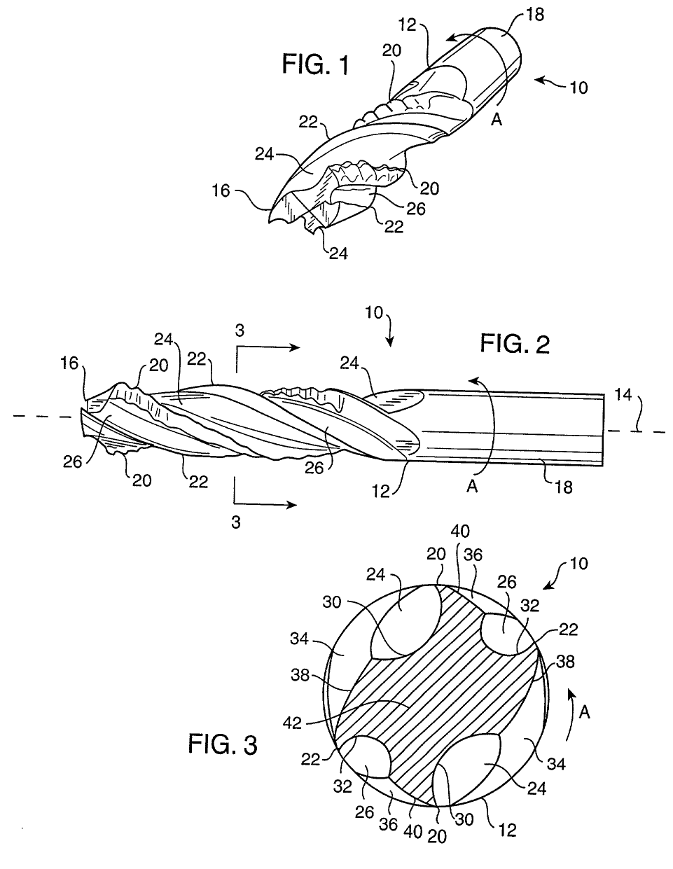

The present invention is described herein and illustrated in FIGS. 1-3 is presented with reference to a router bit (indicated generally at 10). However, as described above, the present invention can be embodied in any type of rotary cutting tool having one or more blades and associated flutes. The tool 10 has a body 12 with an axis of rotation 14. Although the body 12 can be any length and can even be shorter than it is wide, the body 12 preferably is elongated along the axis of rotation 14. The tool 10 has a tip 16 and preferably has a shank 18 opposite the tip for attachment to a driving device in any conventional manner. Other manners for drivably connecting the tool 10 to a driving device exist that do not require the tool 10 to have a shank 18, each of which falls within the spirit and scope of the present invention.

In one preferred embodiment, the tool 10 has four blades 20, 22 and four flutes 24, 26 running from the tip 16 along at least a portion of its length. Two of the blades 20 are roughing blades and two of the blades 22 are finishing blades. Most preferably, the roughing and finishing blades 20, 22 are arranged on the tool 10 to alternate around the circumference of the tool 10, whereby each roughing blade 20 has a finishing blade 22 before it and a finishing blade 22 behind it (in rotation of the tool 10) and whereby each finishing blade 22 has a roughing blade 20 before it and a roughing blade 20 behind it. Rotation of the tool 10 to cut a surface of a workpiece therefore brings alternating roughing and finishing blades 20, 22 to the surface for cutting operations thereon.

The blades 20, 22 can be of any type desired, including without limitation straight, serrated, scalloped, toothed, or sinusoidal blades. Different blade types can exist on the same tool 10, such as straight roughing blades 20 and scalloped finishing blades 22 in the highly preferred embodiment shown in FIGS. 1-3. In less preferred embodiments, different types of roughing blades 20 can be used on the same tool 10 and/or different types of finishing blades 22 can be used on the same tool 10. Where one or more of the blades 20, 22 are serrated or have scallops, teeth, waves, or other shapes, these shapes can be positioned in any manner or pattern along the length of their associated blades 20, 22 relative to the positions of shapes on other blades 20, 22, and can be at any angle with respect to the axis of rotation 14 of the tool 10.

Each blade 20, 22 preferably has a flute 24, 26 associated with it located in front of the blade 20, 22. As used herein and in the appended claims, the terms “in front of” and “behind” and like terms are with reference to one illustrated rotational direction of the tool 10 as indicated by arrow A in FIGS. 1-3. Therefore, each roughing blade 20 preferably has a roughing flute 24 before it and a finishing flute 26 behind it, while each finishing blade 22 preferably has a finishing flute 26 before it and a roughing flute 24 behind it. The roughing and finishing blades 20, 22 preferably run in a helical fashion down the body 12 of the tool 10, with the roughing and finishing flutes 24, 26 running adjacent to the roughing and finishing blades 20, 22 in a similar fashion. It should be noted that the present invention is not limited to blades 20, 22 and flutes 24, 26 having any particular helical pitch, and can even be employed with blades 20, 22 and flutes 24, 26 running parallel or substantially parallel to the axis of rotation 14. Furthermore, the illustrated rotational direction is not intended to limit the scope of the present invention.

With particular reference to FIGS. 1 and 2, the flutes 24, 26 of the present invention are each preferably in the form of a channel or groove running along the body 12 of the tool 10 (whether at an angle with respect to the axis of rotation 14 or not). The flutes 24, 26 can be fully or partially defined by walls of the body 12. For example, the flutes 24, 26 in the tool 10 shown in the figures are defined primarily by cylindrical walls 30, 32 (see FIG. 3), with a relatively small portion of each flute 24, 26 open to an extension channel or groove 34, 36 extending forwardly from the flutes 24, 26. Although optional, the extension channels 34, 36 generate superior cutting results for the blades 20, 22.

The flutes 24, 26 preferably have cylindrical walls 30, 32 as best shown in FIG. 3, but can have any cross-sectional shape desired, including without limitation U-shaped, V-shaped, J-shaped, square, rectangular, oval, and elliptical shapes. When employed, the extension channels 34, 36 preferably slope from the blades 20, 22 circumferentially and radially inwardly toward the flutes 24, 26. The walls 38, 40 defining the extension channels 34, 36 can be substantially planar and straight from the blades 20, 22 to the flutes 24, 26, can be bowed (as best shown in FIG. 3) to any desired extent, can be stepped, faceted, or otherwise have multiple portions at any desired angle(s) with respect to one another (as also shown in FIG. 3 with reference to the minor portion of the walls 38, 40 immediately adjacent to the blade tips and at a slight angle with respect to the remainder of the walls 38, 40 extending to the flutes 24, 26). The walls 38, 40 can have any length and steepness and the extension channels 34, 36 can therefore take any size and shape desired, subject largely to the size of the flutes 24, 26 and tool body 12.

Preferably, at least one of the roughing flutes 24 on the tool body 12 is larger than the finishing flutes 26 and can therefore receive and convey the larger amount of cut material generated by the roughing blades 20. More preferably, all of the roughing flutes 24 are larger than the finishing flutes 26 for this same purpose. Where the roughing and finishing flutes 24, 26 are defined by cylindrical walls as described above and illustrated in the figures, the roughing flutes 24 preferably have radii that are between 1.5 and 2.5 times the size of the radii of the finishing flutes 26 (although even larger or smaller relative ratios are possible). In more highly preferred embodiments, this ratio is between 1.7 and 2.3, while in most highly preferred embodiments, this ratio is about 2.0. In another manner of comparison, the circumferential width of the roughing flutes 24 is preferably between 1.5 and 2.5 times the circumferential width of the finishing flutes 26, more preferably is between 1.7 and 2.3 times the circumferential width of the finishing flutes 26, and most preferably is about twice the circumferential width of the finishing flutes 26. In yet another manner of comparison, the cross-sectional area of a roughing flute 24 is preferably between 2.3 and 6.3 times the cross-sectional area of a finishing flute 26, more preferably is between 2.9 and 5.3 times the cross-sectional area of a finishing flute 26, and most preferably is about 4 times the cross-sectional area of a finishing flute 26.

By employing finishing flutes 26 that are smaller than roughing flutes 24, the finishing flutes 26 can be located circumferentially closer to adjacent roughing flutes 24 than would otherwise be possible in a functional rotary cutting tool design. In this regard, although each finishing flute 26 is preferably located between two roughing flutes 24 (and vice versa), each finishing flute 26 is also preferably located closer to its adjacent roughing flute 24 in front of the finishing flute 26.

Preferably, each roughing flute 24 has a roughing blade 20 therebehind, while each finishing flute 26 has a finishing blade 22 therebehind. The blades 20, 22 can be located a distance behind their corresponding flutes 24, 26, but more preferably are located immediately behind their corresponding flutes 24, 26 (defining an edge of each flute 24, 26 in most preferred embodiments such as that shown in FIGS. 1-3). Employing the preferred flute arrangement as described above, the circumferential distance between a roughing blade 20 and the adjacent finishing blade 22 located behind the roughing blade 20 is preferably 0.4 and 0.7 times the distance between a finishing blade 22 and the adjacent roughing blade 20 located behind the finishing blade 22. More preferably, this ratio is about 0.5. The circumferential distance between a finishing blade 22 and the adjacent roughing blade 20 located behind the finishing blade 22 is 1.5 to 2.0 times the distance between a roughing blade 20 and the adjacent finishing blade 22 located behind the roughing blade 20. More preferably, this ratio is about 2.0.

In another manner of comparison, a roughing blade 20 and an adjacent following finishing blade 22 are preferably separated by between 45 and 75 degrees on the rotary cutting tool body 12. More preferably, this separation is about 60 degrees. A finishing blade 22 and an adjacent following roughing blade 20 are preferably separated by between 90 and 135 degrees on the rotary cutting tool body 12. More preferably, this separation is about 120 degrees.

The circumferential distances and angular separations between the blades 20, 22 on the rotary cutting tool 10 (with the resulting arrangements of flutes 24, 26 thereon) are preferred and can be larger or smaller if desired. In some highly preferred embodiments such as that shown in the figures, roughing blades 20 are positioned in pairs separated by 180 degrees on the cutting tool body 12. Finishing blades 22, roughing flutes 24, and finishing flutes 26 are also preferably located in such a manner. However, as described further below, any arrangement of blades 20, 22 and flutes 24, 26 can be employed.

The rotary cutting tool 10 of the present invention preferably has the same number of roughing blades 20 and flutes 24 as finishing blades 22 and flutes 26, the roughing blades 20 and flutes 24 alternating with the finishing blades 22 and flutes 26 around the body 12. For example, the highly preferred rotary cutting tool 10 illustrated in FIGS. 1-3 has two roughing blades 20 and flutes 24 alternating with two finishing blades 22 and flutes 26. However, in less preferred embodiments, the roughing blades 20 and flutes 24 can outnumber or be outnumbered by the finishing blades 22 and flutes 26, in which case two or more roughing blades 20 and flutes 24 and/or two or more finishing blades 22 and flutes 26 can be located adjacent to one another. While the alternating roughing and finishing blade and flute arrangement is most preferred, these other tool designs are possible and fall within the spirit and scope of the present invention. The rotary cutting tool 10 can have as few as one roughing blade 20 and one finishing blade 22 (with corresponding roughing and finishing flutes 24, 26), but can have any greater number of either of these elements as desired. Although not preferred, the roughing and finishing blades 20, 22 and flutes 24, 26 need not alternate around the body 12 of the rotary cutting tool 10 as described above and shown in the figures. Any other roughing and finishing pattern employing any other roughing to finishing blade and flute ratio is possible (using at least one roughing blade 20, one finishing blade 22, one roughing flute 24, and one finishing flute 26). Preferably however, at least one set of adjacent roughing and finishing blades 20, 22 and flutes 24, 26 exists on the rotary cutting tool 10 and has the preferred spatial relationships described above.

Due to the use of differently-sized roughing and finishing flutes 24, 26, the web 42 defined at least partially by the flutes 24, 26 preferably has an elongated cross section in some highly preferred embodiments such as the one best shown in FIG. 3. This web shape can (and preferably does) result from a four-flute design. Elongated web cross sections such as that of the illustrated four-flute rotary cutting tool 10 preferably have a length to width ratio of between 1.2 and 1.7, more preferably have a length to width ratio of between 1.3 and 1.6, and most preferably have a length to width ratio of about 1.4. Preferably, the web length is defined by opposing finishing flutes 26 while the web width is defined by opposing roughing flutes 24. In other words, the web width and length are defined by the deepest portions of opposing flutes 24, 26 and/or the shortest distance between opposing flutes 24, 26, wherein the maximum depth of the roughing flutes 24 are preferably larger than the maximum depth of the finishing flutes 26.

The roughing and finishing blades 20, 22 of the rotary cutting tool 10 can have the same heights. As used herein, the term “height” in its various forms refers to the radial length of a blade from the axis about which it rotates (e.g., rotary cutting tool axis of rotation 14). In other words, one blade is higher than another if its tip traces a larger circle in rotation than that traced by the other blade in rotation. Superior cutting results can be obtained by employing finishing blades 22 that are higher than the roughing blades 20. Therefore, as the rotary cutting tool 10 rotates, a roughing blade 20 cuts a certain amount of material from a workpiece and is followed by a finishing blade 22 that extends radially further than the roughing blade 20 to cut another amount of material from the workpiece. Preferably, the roughing cut made by the roughing blade 20 is larger than a finishing cut made by following finishing blade 22. In this manner, the roughing blade 20 makes a rough cut of material while the preferably higher finishing blade 22 “cleans up” the surface cut by the roughing blade 20 by more finely removing a smaller amount of material. As the rotary finishing tool 10 continues to rotate and move with respect to the workpiece, additional roughing and finishing cuts are made and result in a finished cut surface (especially where the finishing blades 22 are higher than the roughing blades 20).

Preferably, at least one of the finishing blades 22 is higher than at least one of the roughing blades 20 by between 0.001 inches and 0.004 inches. More preferably, at least one of the finishing blades 20 is higher than at least one of the roughing blades by about 0.002 inches. Even more preferably, all of the finishing blades 22 are higher than all of the roughing blades 20 by between 0.001 inches and 0.004 inches (and most preferably by about 0.002 inches). Although less preferred, different blade height differences are possible and fall within the spirit and scope of the present invention.

With reference again to FIGS. 1 and 2, the tip 16 of the rotary cutting tool has a shape that is at least partially dependent upon the number, shape, and spacing of the blades 20, 22 and flutes 24, 26 described above. The blades 20, 22 and flutes 24, 26 can terminate in a pointed tip, a flat or substantially flat tip, a tip 16 having a concave profile, a tip having a curved, blunted, rounded, or other profile, or in any other tip shape desired.

With particular reference to the appended claims, it should be noted that when reference is made to one flute being larger or smaller than another, or when reference is made to one flute and/or blade being closer or farther away from another flute and/or blade, such a relationship is understood to mean more than an insignificant or unintended difference. For example, such claim text does not contemplate differences in flute or blade size and/or position generated merely by machining tolerance variables.

Also with reference to the appended claims, a particular number of claim elements claimed (e.g., two roughing blades, a finishing flute, and the like) does not indicate or imply that more such elements cannot or do not exist in the claimed device or method.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

I claim:

1. A rotary cutting tool, comprising:
an elongated body having:
an axis; and
a circumference about the axis;
two roughing flutes circumferentially spaced about the elongated body; and
two finishing flutes circumferentially spaced about the elongated body, the finishing and roughing flutes positioned in an alternating manner about the circumference of the body;
at least one of the finishing flutes being circumferentially located closer to one circumferentially adjacent roughing flute than another circumferentially adjacent roughing flute.

2. The rotary cutting tool as claimed in claim 1, wherein the two roughing flutes are spaced about 180 degrees apart on the elongated body.

3. The rotary cutting tool as claimed in claim 1, wherein the two finishing flutes are spaced about 180 degrees apart.

4. The rotary cutting tool as claimed in claim 3, wherein the two roughing flutes are spaced about 180 degrees apart.

5. The rotary cutting tool as claimed in claim 1, wherein the rotary cutting tool has a rotational direction, at least one of the finishing flutes being located circumferentially closer to an adjacent roughing flute in the rotational direction than to an adjacent roughing flute in a direction opposite to the rotational direction.

6. The rotary cutting tool as claimed in claim 1, wherein at least one of the roughing flutes is larger than at least one of the finishing flutes.

7. The rotary cutting tool as claimed in claim 1, wherein:
at least one of the roughing flutes and at least one of the finishing flutes has a concave curved wall with respective radii; and
the radius of the at least one roughing flute is larger than the radius of the at least one finishing flute.

8. The rotary cutting tool as claimed in claim 1, further comprising:
a roughing blade adjacent to each roughing flute; and
a finishing blade adjacent to each finishing flute;
wherein at least one of the finishing blades extends a distance from the axis of between 0.001 and 0.004 inches greater than at least one of the roughing blades.

9. The rotary cutting tool as claimed in claim 8, wherein at least one of the finishing blades extends from the axis about 0.002 inches more than at least one of the roughing blades.

10. The rotary cutting tool as claimed in claim 1, wherein:
at least part of at least one roughing flute has a roughing flute radius;
at least part of at least one finishing flute has a finishing flute radius; and
the roughing flute radius is between 1.5 and 2.5 times larger than the finishing flute radius.

11. The rotary cutting tool as claimed in claim 10, wherein the roughing flute radius is about twice as large as the finishing flute radius.

12. The rotary cutting tool as claimed in claim 1, further comprising:
a roughing blade adjacent to each roughing flute; and
a finishing blade adjacent to each finishing flute;
the roughing blades separated from the finishing blades across the finishing flutes by between 45 and 75 degrees.

13. The rotary cutting tool as claimed in claim 12, wherein the roughing blades are separated from the finishing blades across the finishing flutes by about 60 degrees.

14. The rotary cutting tool as claimed in claim 1, further comprising:
a roughing blade adjacent to each roughing flute; and
a finishing blade adjacent to each finishing flute;
wherein:
the roughing blades are separated from the finishing blades across the finishing flutes by a first circumferential distance;
the roughing blades are separated from the finishing blades across the roughing flutes by a second circumferential distance; and
the first circumferential distance is between 1.5 and 2.5 times larger than the second circumferential distance.

15. The rotary cutting tool as claimed in claim 14, wherein the first circumferential distance is about 2.0 times larger than the second circumferential distance.

16. The rotary cutting tool as claimed in claim 1, wherein:
the roughing flutes are separated by a distance defining a web thickness of the elongated body;
the finishing flutes are separated by a distance defining a web length of the elongated body; and
the web length is between 1.2 and 1.7 times larger than the web thickness.

17. The rotary cutting tool as claimed in claim 16, wherein the web length is 1.4 times larger than the web thickness.

18. A rotary cutting tool, comprising:
a roughing flute having a maximum depth; and
a finishing flute located a circumferential distance from the roughing flute about the cutting tool;
the finishing flute having a maximum depth smaller than that of the roughing flute.

19. The rotary cutting tool as claimed in claim 18, wherein at least a portion of the roughing flute has a concave curved surface defining the maximum depth of the roughing flute.

20. The rotary cutting tool as claimed in claim 18, wherein at least a portion of the finishing flute has a concave curved surface defining the maximum depth of the finishing flute.

21. The rotary cutting tool as claimed in claim 19, wherein at least a portion of the finishing flute has a concave curved surface defining the maximum depth of the finishing flute.

22. The rotary cutting tool as claimed in claim 18, wherein:
the roughing and finishing flutes have respective circumferential widths; and
the roughing flute circumferential width is between 1.5 and 2.5 times larger than the finishing flute circumferential width.

23. The rotary cutting tool as claimed in claim 22, wherein the roughing flute circumferential width is about twice as large as the finishing flute circumferential width.

24. The rotary cutting tool as claimed in claim 18, wherein the roughing flute is a first roughing flute, the rotary cutting tool further comprising a second roughing flute, wherein:
the finishing flute is flanked by the first and second roughing flutes; and
the finishing flute is located circumferentially closer to the first roughing flute than the second roughing flute.

25. The rotary cutting tool as claimed in claim 24, further comprising:
a first roughing blade located between the first roughing flute and the finishing flute; and
a finishing blade located between the finishing flute and the second roughing flute; and
a second roughing blade located adjacent to the second roughing flute opposite the finishing blade;
wherein the first roughing blade and the finishing blade are separated by a circumferential distance that is between 0.4 and 0.7 times that between the finishing blade and the second roughing blade.

26. The rotary cutting tool as claimed in claim 25, wherein the first roughing blade and the finishing blade are separated by a circumferential distance that is about half that between the finishing blade and the second roughing blade.

27. The rotary cutting tool as claimed in claim 18, wherein the finishing flute is a first finishing flute, the rotary cutting tool further comprising a second finishing flute, wherein:
the roughing flute is flanked by the first and second finishing flutes; and
the roughing flute is located circumferentially closer to the second finishing flute than the first finishing flute.

28. The rotary cutting tool as claimed in claim 27, further comprising:
a first finishing blade located between the first finishing flute and the roughing flute; and
a roughing blade located between the roughing flute and the second finishing flute; and
a second finishing blade located adjacent to the second finishing flute opposite the roughing blade;
wherein the first finishing blade and the roughing blade are separated by a circumferential distance that is between 1.5 and 2.5 times that between the roughing blade and the second finishing blade.

29. The rotary cutting tool as claimed in claim 28, wherein the first finishing blade and the roughing blade are separated by a circumferential distance that is about twice that between the roughing blade and the second finishing blade.

30. The rotary cutting tool as claimed in claim 18, wherein a web of the rotary cutting tool is at least partially defined by the flutes, and wherein the web has a length to width ratio of between 1.2 and 1.7.

31. The rotary cutting tool as claimed in claim 30, wherein the web has a length to width ratio of about 1.4.

32. The rotary cutting tool as claimed in claim 18, further comprising:
a roughing blade adjacent to the roughing flute; and
a finishing blade adjacent to the finishing flute;
the finishing blade radially extending between 0.001″ and 0.004″ more than the roughing blade.

33. The rotary cutting tool as claimed in claim 32, wherein the finishing blade radially extends about 0.002″ more than the roughing blade.

34. The rotary cutting tool as claimed in claim 18, wherein:
the rotary cutting tool has a direction of rotation;
the roughing flute is in front of the finishing flute with respect to the direction of rotation;
the rotary cutting tool further comprising a finishing blade behind the finishing flute with respect to the direction of rotation, the finishing blade separated from the roughing flute by between 45 and 75 degrees.

35. The rotary cutting tool as claimed in claim 34, wherein the finishing blade is separated from the roughing flute by about 60 degrees.

36. A method of cutting a surface of a workpiece using a rotary cutting tool, comprising:
rotating a roughing flute past the surface;
rotating a roughing blade past the surface to cut a first layer of material from the surface;
rotating a finishing flute past the surface, the finishing flute being smaller than the roughing flute; and
rotating a finishing blade past the surface to cut a second layer of material from the surface.

37. The method as claimed in claim 36, wherein:
the finishing blade follows the roughing blade in rotation of the rotary cutting tool;
the roughing blade and the finishing blade are separated by first circumferential distance on the rotary cutting tool; and
the finishing blade is separated from a blade following the finishing blade in rotation of the rotary cutting tool by a second circumferential distance different from the first circumferential distance.

38. The method as claimed in claim 37, wherein the blade following the finishing blade is the roughing blade.

39. The method as claimed in claim 37, wherein the blade following the finishing blade is another roughing blade.

40. The method as claimed in claim 36, further comprising:
rotating at least one additional roughing flute, one additional roughing blade, one additional finishing flute, and one additional finishing blade past the surface;
wherein successive blades passing the surface are separated by different circumferential distances on the rotary cutting tool.

41. The method as claimed in claim 40, wherein a finishing blade follows behind a roughing blade on the rotary cutting tool a smaller circumferential distance than a roughing blade follows behind a finishing blade.

42. The method as claimed in claim 40, wherein:
the finishing blade follows behind the roughing blade by a circumferential distance; and
an additional roughing blade follows behind the finishing blade by 1.5 to 2.5 times the circumferential distance between the finishing and roughing blades.

43. The method as claimed in claim 40, wherein:
the finishing blade follows behind the roughing blade by a circumferential distance; and
an additional roughing blade follows behind the finishing blade by about twice the circumferential distance between the finishing and roughing blades.

44. The method as claimed in claim 36, wherein the finishing flute is smaller than the roughing flute.

45. The method as claimed in claim 36, wherein:
the finishing and roughing flutes each have a radius; and
the roughing flute radius is about twice as large as the finishing flute radius.

46. The method as claimed in claim 36, wherein the roughing and finishing blades are separated across the finishing flute by between 45 and 75 degrees of the rotary cutting tool.

47. The method as claimed in claim 36, wherein the roughing and finishing blades are separated across the finishing flute by about 60 degrees of the rotary cutting tool.

48. The method as claimed in claim 36, further comprising:
generating chips by cutting layers from the surface; and
conveying the chips in the roughing and finishing flutes along the rotary cutting tool, wherein more chips are conveyed in the finishing flute than in the roughing flute.

49. The method as claimed in claim 36, wherein the finishing blade cuts deeper into the surface of the workpiece than the roughing blade.

50. The method as claimed in claim 49, wherein the finishing blade cuts between 0.001″ and 0.004″ deeper into the surface of the workpiece than the roughing blade.

51. The method as claimed in claim 50, wherein the finishing blade cuts about 0.002″ deeper into the surface of the workpiece than the roughing blade.
